(19) United States
(12) Patent Application Publication
(10) Pub. No.: US 2007/0174204 A1
(43) Pub. Date: Jul. 26, 2007

(54) Purchasing and copy protecting method for a digital content

(75) Inventors: Sung-Min Pae, Chung Ho City (TW); Hyun Chul Park, Chung Ho City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: POWER QUOTIENT INTERNATIONAL CO., LTD.

(21) Appl. No.: 11/443,035

(22) Filed: May 31, 2006

(30) Foreign Application Priority Data
Jan. 26, 2006 (TW) 095103056

(51) Int. Cl. H04N 7/16; H04L 9/32; G06Q 99/00; G06F 17/30; G06F 7/04; H04L 9/00; G06K 9/00; H04K 1/00; H03M 1/68

(52) U.S. Cl. 705/59; 705/57; 705/52; 726/26; 726/27

(57) ABSTRACT

The present invention relates to a purchasing and copy protecting method for a digital content, comprising the steps of: a user of an electronic device buying a digital content from a supplier through a network, wherein the electronic device at least includes a set of first identification codes and a connection port; the supplier storing the digital content along with the a set of second identification codes in a medium, and storing a set of third identification codes in a storage device, wherein the storage device can access the medium; the supplier delivering the storage device and/or the medium to the user; and the user inserting the medium into the storage device, and connecting the electronic device to the storage device, then the electronic device checking whether the first identification codes, the second identification codes and the third identification codes are matched or not; if yes, then the electronic device can read the medium in the storage device; if not, then the electronic device can not read the medium in the storage device.

### BACKGROUND OF THE INVENTION

1. Field of the Invention

The present invention relates to a purchasing and copy protecting method for a digital content, and more particularly to a portable electronic device which will check whether its own identification code, the identification code provided from a supplier, the identification code of a medium and the identification code of a storage device are matched or not; if yes, then the electronic device can read the medium; if not, then the electronic device can not read the medium in the device.

2. Description of the Related Art

In general, audio and video files can be downloaded from a server and played in a DVD or CD player by means of a simple security check according to a prior art. However, the security check may be skipped by users, and thus DVD or CD publishers cannot request users to pay for the downloaded files and thus the unauthorized use of DVD or CD media becomes more and more.

Furthermore, at present, a user can not get an identification code from the supplier when he/she buys computer software(s), DVD or CD through a network; therefore, the supplier can not effectively stop the user from illegally copying the computer software(s), DVD or CD, such that the benefit of the supplier will be harmed. Furthermore, the computer software(s), DVD or CD does not have the read-once function; therefore, its sale price remains higher, thus user will be less willing to buy the legal computer software(s), DVD or CD.

At present, the DVD has developed some new specifications, such as Blu-ray DVD and HD DVD, wherein, the Blu-ray DVD is the standard of the next generation optical disk format. Due to the quality requirement of the multi-media from human is increasing day by day, the Blu-ray DVD could be used to store the high resolution audio, video and high capacity data, while the HD DVD, similar to the Blu-ray DVD, is also the format of next generation optical disk.

At present, there are systems or solutions that can solve the problem of protecting DVD or CD from unauthorized copying. For example, U.S. Pat. No. 5,991,403 issued to Aucsmith, et al disclosed a method for encoding MPEG compatible video data for subsequent compression that comprises detecting a plurality of frames of video data organized as a GOP, generating an encryption key for the GOP, and encrypting the video data using GOP-synchronized substitution, transposition, and rotation transformations that are parameterized by offsets derived from the generated encryption key.

U.S. Pat. No. 5,915,018 issued to Aucsmith, et al disclosed a cryptographic system and method for secure distribution and management of cryptographic keys for use in a DVD copy protection scheme. A DVD disc having compressed, encrypted content written on a first portion of the disc, and the content encryption key, itself encrypted with a second key and written out of band on a second portion of the disc is used to provide content, key, and control information to a DVD player.

The U.S. Pat. No. 5,991,403 disclosed a method for encoding MPEG compatible video data for subsequent compression; while the U.S. Pat. No. 5,915,018 disclosed a cryptographic system and method for secure distribution and management of cryptographic keys for use in a DVD copy protection scheme. However, the prior arts could not provide a system or method used for a portable electronic device, for example but not limited to a portable media play device with a display device, such as a LCD for legally playing computer software(s), audio file(s) or video file(s) in the CD, DVD. Furthermore, the computer software(s), DVD or CD does not have the read-once feature; therefore, the sale price of the CDs or DVDs could not be reduced.

### SUMMARY OF THE INVENTION

Therefore, it is a primary objective of the present invention to overcome the foregoing shortcomings of the prior art by providing a purchasing and copy protecting method for a digital content, which will check whether its own identification code, the identification code provided from a supplier, the identification code of a medium and the identification code of a storage device are matched or not; if yes, then the portable electronic device can read the medium; if not, then the portable electronic device can not read the medium in the device.

Another objective of the present invention is to overcome the foregoing shortcomings of the prior art by providing a purchasing and copy protecting method for a digital content, which provides a read-once medium for reducing the sale price of the CDs or DVDs.

Another objective of the present invention is to overcome the foregoing shortcomings of the prior art by providing a purchasing and copy protecting method for a digital content, which will read the medium and delete the content of the medium after reading the medium, so as to resolve the problem of computer software(s), DVD or CD illegal copying.

Another objective of the present invention is to overcome the foregoing shortcomings of the prior art by providing a purchasing and copy protecting method for a digital content, user can give the storage device or medium to other user as a gift or sell the storage device or medium to other user and will not affect the right of the computer software(s), DVD or CD publisher.

To achieve the foregoing objectives, a purchasing and copy protecting method for a digital content in accordance with the present invention comprising the steps of: a user of an electronic device buying a digital content from a supplier through a network, wherein the electronic device at least includes a set of first identification codes and a connection port; the supplier storing the digital content along with the a set of second identification codes in a medium, and storing a set of third identification codes in a storage device, wherein the storage device can access the medium; the supplier delivering the storage device and/or the medium to the user; and the user inserting the medium into the storage device, and connecting the electronic device to the storage device, then the electronic device checking whether the first identification codes, the second identification codes and the third identification codes are matched or not; if yes, then the portable electronic device can read the medium in the storage device; if not, then the portable electronic device can not read the medium in the storage device.

### BRIEF DESCRIPTION OF THE DRAWINGS

FIG. 1 is a flowchart of a purchasing and copy protecting method for a digital content according to a preferred embodiment of the invention.

FIG. 2 is an operation chart of a purchasing and copy protecting method for a digital content according to a preferred embodiment of the invention.

### DETAILED DESCRIPTION OF THE PREFERRED EMBODIMENTS

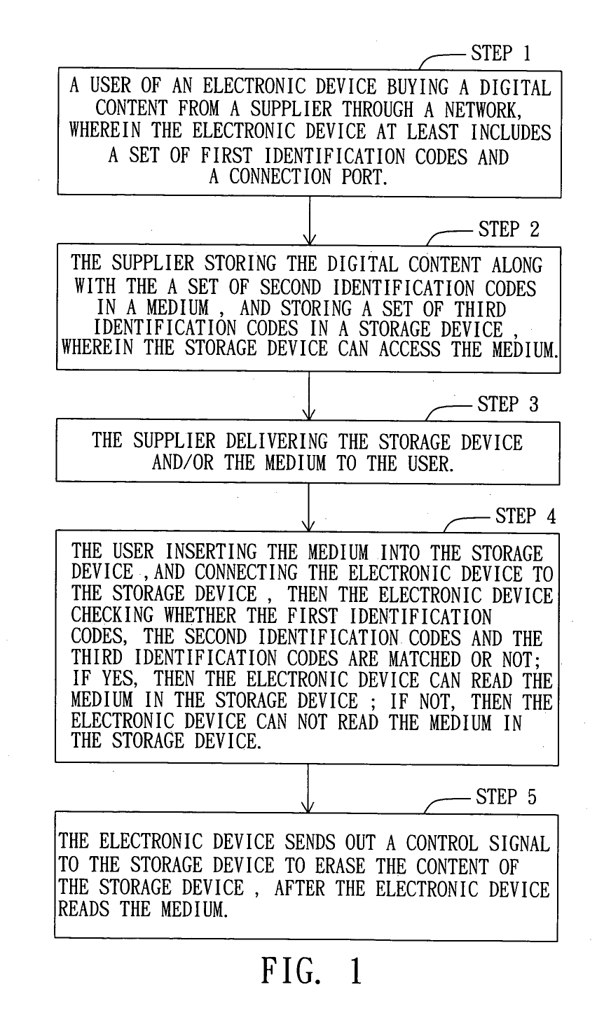

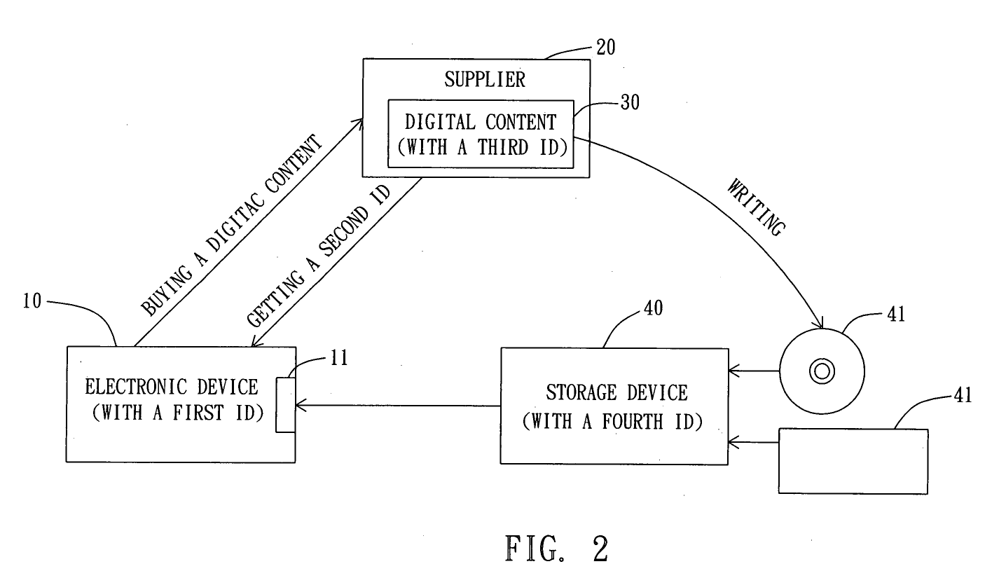

Referring to FIG. 1 and FIG. 2, wherein FIG. 1 shows a flowchart of a purchasing and copy protecting method for a digital content according to a preferred embodiment of the invention; FIG. 2 shows an operation chart of a purchasing and copy protecting method for a digital content according to a preferred embodiment of the invention. As shown in the FIG. 1, the purchasing and copy protecting method for a digital content in accordance with the present invention comprising the steps of: a user of an electronic device 10 buying a digital content 30 from a supplier 20 through a network, wherein the electronic device 10 at least includes a set of first identification codes and a connection port 11 (step 1); the supplier 20 storing the digital content 30 along with the a set of second identification codes in a medium 41, and storing a set of third identification codes in a storage device 40, wherein the storage device 40 can access the medium 41 (step 2); the supplier 20 delivering the storage device 40 and/or the medium 41 to the user (step 3); and the user inserting the medium 41 into the storage device 40, and connecting the electronic device 10 to the storage device 40, then the electronic device 10 checking whether the first identification codes, the second identification codes and the third identification codes are matched or not; if yes, then the electronic device 10 can read the medium 41 in the storage device 40; if not, then the electronic device 10 can not read the medium 41 in the storage device 40 (step 4).

In step 1, the electronic device 10 is a portable electronic device and for example but not limited to a portable audio/video playback device, and comprises a set of first identification codes (ID), and the first identification codes are unique codes, for example but not limited to a producing serial number of the portable electronic device 10 or its CPU. The connection port 11 is for example but not limited to a USB port, an IEEE1394 port, a SATA port, an IDE port or a port with other interface. The digital content 30 is a computer program, CD music, DVD, Blu-ray, HD DVD movie, or VCD movie, and the digital content 30 is authorized from a contents provider to the supplier 20 for manufacturing or selling. The network is an internet or a telephone network, for the purpose of explaining, the present embodiment uses the telephone network as an example, but it is not to limit the scope of the present invention.

In step 2, the supplier 20 storing the digital content 30 along with the a set of second identification codes in a medium 41, and storing a set of third identification codes in a storage device 40, wherein the storage device 40 can access the medium 41. Furthermore, the supplier 20 further provides a set of fourth identification codes to the user through the network when the user buys the digital content 30 from the supplier 20 through the network. At the same time, the supplier 20 stores the third identification codes along with the digital content 30 ordered by the user into the medium 41. The medium 41 is a hard disk (such as a 3.5″, 2.5″, 1.8″, 1″ or 0.8″ hard disk), an optical storage medium (such as a CD, DVD, Blu-ray, HD DVD or VCD) or a memory card. Furthermore, the storage device 40 comprises a set of fourth identification codes set by the supplier 20, which is for example but not limited to a CD player, a VCD player, a DVD player/recorder, HD DVD player/recorder, Blu-ray player, HD DVD player/recorder or a USB card reader, or a USB flash memory device. When the medium 41 is a CD, DVD or VCD, the storage device 40 is a CD player, a VCD player, a DVD player/recorder, HD DVD player/recorder, Blu-ray player, HD DVD player/recorder. When the medium 41 is a memory card, the storage device 40 is a card reader with a USB interface or a flash memory storage device with a USB interface for accessing the digital content 30 stored in the medium 41. Furthermore, the digital content 30 also is an authorized read-once computer program, CD music, DVD, Blu-ray, HD DVD movie, or VCD movie. The memory card is for example but not limited to a Compact Flash, Microdrive, mini SD, MMC, Security Digital, RSMMC Memory Stick, Memory Stick Pro, XD, Memory Stick Duo, or memory Stick Pro Duo memory card. Furthermore, the first identification codes, the second identification codes, the third identification codes, and the fourth identification codes are unique.

In steps 3, the supplier 20 can sell the storage device 40 and medium 41 stored with the digital content 30 separately. When the user is a new customer, he/she can order the storage device 40 and medium 41 simultaneously through the network due to he/she does not have the storage device 40. When the user is a old customer or a new customer who can get the medium 41 from other source, he/she can only order the storage device 40 through the network, thus, the storage device 40 and the medium 41 of the present invention still have retained its value, that is, the user can give the storage device 40 or medium 41 to other user as a gift or sell the storage device 40 or medium 41 to other user.

In steps 4, the user inserts the medium 41 into the storage device 40, and connects the electronic device 10 to the storage device 40, then the electronic device 10 will check whether the first identification codes, the second identification codes, the third identification codes and the fourth identification codes are matched or not; if yes, then the electronic device 10 can read the medium 41 in the storage device 40 to execute the computer program of the medium 41 or to play the DVD, Blu-ray, HD DVD movie, or VCD movie of the medium 41; if any one of the four identification codes is not matched, then the electronic device 10 can not read the medium 41 in the storage device 40.

Furthermore, the purchasing and copy protecting method for a digital content of the present invention further comprises a step of: the electronic device 10 sends out a control signal to the storage device 40 to erase the content of the storage device 40, after the electronic device 10 reads the medium 41 (step 5). Wherein, the electronic device 10 will send out a control signal to the storage device 40 after reading the medium 41 to erase the content of the medium 41 when the digital content 30 is an authorized read-once computer program, CD music, DVD, Blu-ray, HD DVD movie, or VCD movie, such that the digital content 30 of the medium 41 can not be executed or read anymore.

Therefore, by way of using the purchasing and copy protecting method for a digital content of the present invention, the user can execute the computer program or play the CD music, DVD, Blu-ray, HD DVD movie, or VCD movie when he/she receives the medium 41 and the electronic device 10 will send out a control signal to the storage device 40 after reading the medium 41 to erase the content of the medium 41, so as to protect the right of the publisher and reduce the sale price of the computer program, CD music, DVD, Blu-ray, HD DVD movie, or VCD movie.

Wherein, when the medium 41 is a memory card, the user can use the deleted (or blank) medium 41 as a general storage device or send it back to the supplier 20 for storing the new content therein when the user orders a new content.

With the implementation of the present invention, the electronic device 10 will check whether the first identification codes, the second identification codes, the third identification codes and the fourth identification codes are matched or not; if yes, then the electronic device 10 can read the medium 41 in the storage device 40; if any one of the four identification codes is not matched, then the electronic device 10 can not read the medium 41 in the storage device 40; therefore, the purchasing and copy protecting method for a digital content of the present invention can overcome the shortcomings of the prior arts.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A purchasing and copy protecting method for a digital content, comprising the steps of:
a user of an electronic device buying a digital content from a supplier through a network, wherein said electronic device at least includes a set of first identification codes and a connection port;
said supplier storing said digital content along with said a set of second identification codes in a medium, and storing a set of third identification codes in a storage device, wherein said storage device can access said medium;
said supplier delivering said storage device and/or said medium to said user; and
said user inserting said medium into said storage device, and connecting said electronic device to said storage device, then said electronic device checking whether said first identification codes, said second identification codes and said third identification codes are matched or not; if yes, then said electronic device can read said medium in said storage device; if not, then said electronic device can not read said medium in said storage device.

2. The purchasing and copy protecting method for a digital content of claim 1, wherein said electronic device is a portable audio/video playback device.

3. The purchasing and copy protecting method for a digital content of claim 1, wherein said supplier further provides a set of fourth identification codes to said user through said network in the step of said supplier storing said digital content along with said a set of second identification codes in a medium.

4. The purchasing and copy protecting method for a digital content of claim 3, wherein said electronic device will check whether said first identification codes, said second identification codes, said third identification codes and said fourth identification codes are matched or not; if yes, then said electronic device can read said medium in said storage device and delete the content of said medium after reading the content of said medium; if not, then said electronic device can not read said medium in said storage device.

5. The purchasing and copy protecting method for a digital content of claim 1, wherein said storage device is a CD player, a VCD player, a DVD player/recorder, HD DVD player/recorder, Blu-ray player, HD DVD player/recorder or a USB card reader, or a USB flash memory device.

6. The purchasing and copy protecting method for a digital content of claim 1, wherein said medium is a 3.5″, 2.5″, 1.8″, 1.0″ or 0.8″ hard disk.

7. The purchasing and copy protecting method for a digital content of claim 1, wherein said medium is an optical storage medium, it could be a CD, DVD, Blu-ray, HD DVD or VCD.

8. The purchasing and copy protecting method for a digital content of claim 1, wherein said medium is a memory card, it could be a Compact Flash, Microdrive, mini SD, MMC, Security Digital, RSMMC Memory Stick, Memory Stick Pro, XD, Memory Stick Duo, or memory Stick Pro Duo memory card.

9. The purchasing and copy protecting method for a digital content of claim 7, wherein said digital content is an authorized read-once computer program, CD music, DVD, Blu-ray, HD DVD movie, or VCD movie.

10. The purchasing and copy protecting method for a digital content of claim 3, wherein said first identification codes, said second identification codes, said third identification codes, and said fourth identification codes are unique.

11. The purchasing and copy protecting method for a digital content of claim 1, wherein said connection port is a USB port, an IEEE1394 port, a SATA port, an IDE port or a port with other interface.

12. The purchasing and copy protecting method for a digital content of claim 1, wherein said electronic device sends out a control signal to said storage device to erase the content of said storage device, after said electronic device reads said medium.

13. The purchasing and copy protecting method for a digital content of claim 1, wherein said network is an internet or a telephone network.
